(19) United States
(12) Patent Application Publication
(10) Pub. No.: US 2008/0074533 A1
(43) Pub. Date: Mar. 27, 2008

(54) DIGITAL IMAGE CAPTURING DEVICE AND METHOD OF AUTOMATIC SHOOTING THEREOF

(76) Inventor: Kuo-Hung Liao, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/668,244

(22) Filed: Jan. 29, 2007

(30) Foreign Application Priority Data
Sep. 22, 2006 (TW) 095135282

(51) Int. Cl. H04N 5/238

(52) U.S. Cl. 348/363

(57) ABSTRACT

A method of automatic shooting, which is applied to a digital image capturing device, using an image recognition technology is disclosed. The method comprises: activating an automatic shooting process; capturing a gesture image of an object; determining whether the image is a predefined image or not by using the image recognition technology; and executing a predefined shooting procedure.

### BACKGROUND OF THE INVENTION

1. Field of the Invention

The present invention relates to an automatic shooting method, and more particularly, to a method which is achieved through the utilization of an image recognition technology.

2. Description of the Related Art

Digital image capturing devices (digital cameras or digital camcorders) have become more prevalent as technology advances. Generally speaking, digital cameras or digital camcorders in precedent technologies usually allowed users to utilize an internal timer to perform automatic shooting. In order to start an automatic shooting process in precedent technologies, a user needs to select an object and to activate an automatic shooting button on the digital image capturing device first, and then the user needs to move to a predetermined position within certain time period (for example, 5 seconds) to complete the automatic shooting process.

However, since this type of automatic shooting method has a time constraint, no mistakes are allowed during the process. For example, if the user fails to make a desired pose in time or other unexpected problems happen, the pictures taken may not be of optimal quality and choice. Therefore, this shooting method has drawbacks and is not convenient for the user.

There is another type of automatic shooting method in precedent technologies, whereby shooting is performed through the utilization of a remote control controlling the digital image capturing device. However, an implementation of the remote control will incur extra costs, and the digital image capturing device will need to be embedded with an extra remote control receiver.

Therefore, a new shooting method is needed to solve the aforementioned problems in the precedent technologies.

### SUMMARY OF THE INVENTION

The main objective of the present invention is to provide an automatic shooting method which utilizes image recognition technology.

In order to achieve the objective, the present invention first provides a digital image capturing device which comprises a processor, an image capturing module, a memory, and an indicating device, all of which are electronically coupled with each other. The processor is used to control the image capturing module, the memory, and the indicating device so as to execute an image recognition function, identifying an image captured by the image capturing module and a predefined identification data of an identification database stored in the memory.

Moreover, the present invention also provides a method of automatic shooting of a digital image capturing device. First, a user selects an object and presses the automatic shooting button on the digital image capturing device so as to activate the automatic shooting process. Then the indicating device emits signals to show that the automatic shooting process has been activated. After that, the user moves to a predetermined position and makes a gesture (such as waving his/her hand), which will then be captured by the image capturing module. Then the processor proceeds with the instant image recognition procedure to identify the captured image. Thereafter, the processor determines whether the image of the user's gesture matches any gesture images predefined in the identification database. If they match, the indicating device will send out different signals to inform the user. Last, the digital image capturing device will execute a shooting procedure corresponding to the user's gesture after a specific number of seconds.

### BRIEF DESCRIPTION OF THE DRAWINGS

FIG. 1 illustrates a frame structure of a digital image capturing device of the present invention.

FIG. 2 is a flow chart of an automatic shooting method of the present invention.

### DETAILED DESCRIPTION OF THE PREFERRED EMBODIMENT

The advantages and innovative features of the invention will become more apparent from the following detailed description when taken in conjunction with the accompanying drawings.

The present invention provides an automatic shooting method and a desirable digital image capturing devices thereof. The digital image capturing device can either be a digital camera or a digital camcorder; however, the present invention is not confined to these devices.

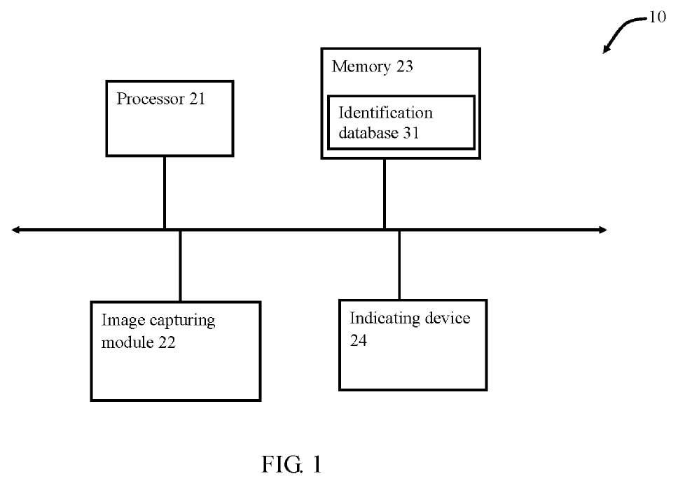

Please refer to FIG. 1, which illustrates a frame structure of a digital image capturing device of the present invention. As shown in FIG. 1, the digital image capturing device 10 comprises a processor 21, an image capturing module 22, a memory 23 and an indicating device 24, all of which are electronically coupled with each other. The image capturing module 22, the memory 23 and the indicating device 24 are controlled by the processor 21. The processor 21 is also used to perform image recognition and is capable of identifying dynamic or stationary images captured by the image capturing module 22. The image capturing module 22 can comprises elements such as a CCD or a CMOS for capturing dynamic or stationary images. The memory 23 stores an identification database 31 and the necessary application programs for the operation of the digital image capturing device 10. The identification database 31 is used to store the identification data, such as the predefined gestures, and these data are retrieved during the image recognition. The application of the identification database 31 will be discussed in detail in the subsequent section. The indicating device 24 is used to inform the user the automatic shooting process of the digital image capturing device 10, and the preferred indicating device 24 is a flashing device (for example, LED indicating light) or a beeping device; however, the present invention is not confined to these devices.

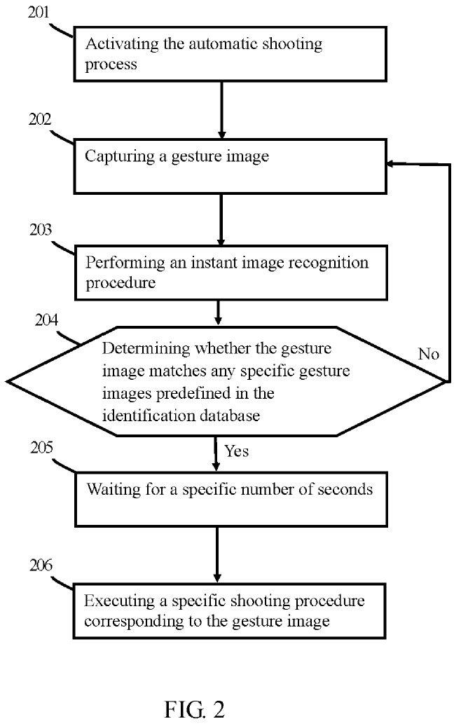

Refer to FIG. 2, which shows a flow chart of an automatic shooting method of the present invention.

First, the present invention proceeds with step 201: activating the automatic shooting process.

The user first needs to select an object and presses the automatic shooting button on the digital image capturing device 10 so as to activate the automatic shooting process. At the same instant, the digital image capturing device 10 can use the indicating device 24 to send out signals so as to inform the user that the automatic shooting process has been activated. The preferred indicating signal is flash light or beep, but the present invention is not confined to these signals.

The present invention then proceeds with step 202: capturing a gesture image.

In step 202, when the user moves to a predetermined position and makes a gesture predefined in the identification database 31, such as waving his/her or making specific hand motions (such as extending three fingers or making a V-shaped gesture), the image capturing module 22 of the present invention will then capture the image of such gesture.

The present invention then proceeds with step 203: performing an instant image recognition procedure.

After the image capturing module 22 captures the image of the user's gesture, the processor 21 then performs the instant image recognition procedure via the image recognition technology, and identifies the gesture image captured by the image capturing module 22.

The present invention then proceeds with step 204: determining whether the gesture image matches any specific gesture image predefined in the identification database. After the processor 21 successfully identifies the gesture image captured by the image capturing module 22, the processor 21 then determines whether the user's gesture image matches any specific gesture images predefined in the identification database 31. If the user's gesture image fits to a specific gesture predefined in the identification database 31, then the indicating device 24 will send out signals to inform the user and then proceeds with step 205. In a preferred embodiment of the present invention, the signals sent from the indicating device 24 during step 204 and step 201 are different, so the user can easily distinguish the difference between the two signals. If the processor 21 cannot identify the gesture image captured by the image capturing module 22 or if the user's gesture image does not correspond to any specific gesture images predefined in the identification database 31, the indicating device 24 will send out a different signal to inform the user, and the present invention will return to step 202 and recapture the user's gesture image.

The present invention then proceeds with step 205: waiting for a specific number of seconds.

In order to provide the user with enough time to make a chosen pose, after the image recognition is finished, the digital image capturing device 10 can delay a few seconds (for example, 5 seconds) before entering into the next shooting procedure. The length of the delay can be adjusted and is not confined to 5 seconds.

Last, the present invention then proceeds with step 206: executing a specific shooting procedure. After waiting for a specific number of seconds, the digital image capturing device 10 can execute a specific shooting procedure. Pay extra attention that in the present invention, different gestures can have different shooting procedures. For example, hand waving can activate the shooting procedure to take a single image, and extending three fingers can activate the shooting procedure to take three consecutive pictures. Furthermore, the present invention is capable of performing different shooting instructions of the digital image capturing device 10 by identifying the setting in the identification database 31. For example, by a specific user's gesture, the camera lens can be directed to zoom in or zoom out, or the flash light can be activated; thus, the present invention is not confined to the aforementioned gestures and shooting procedures.

Although the present invention has been explained in relation to its preferred embodiments, it is to be understood that many other possible modifications and variations can be made without departing from the spirit and the scope of the invention as hereinafter claimed.

What is claimed is:

1. An automatic shooting method applied to a digital image capturing device, comprising:
activating an automatic shooting process;
capturing a gesture image;
performing an instant image recognition procedure according to the gesture image;
determining whether the gesture image matches any predefined dynamic images stored in an identification database; and
executing a specific shooting procedure corresponding to the gesture image if the gesture image matches a predefined dynamic image.

2. The automatic shooting method as claimed in claim 1, wherein the gesture image of the step of capturing a gesture image is a gesture image of a user.

3. The automatic shooting method as claimed in claim 1, wherein the automatic shooting process is activated via an automatic shooting button.

4. The automatic shooting method as claimed in claim 1, wherein the identification database has a plurality of predefined dynamic images, and each predefined dynamic image is specified to a specific shooting procedure.

5. The automatic shooting method as claimed in claim 1, further comprising a step of indicating a recognition status through an indicating device.

6. The automatic shooting method as claimed in claim 5, wherein the indicating device used in the step of indicating a recognition status is a flashing device.

7. The automatic shooting method as claimed in claim 5, wherein the indicating device used in the step of indicating a recognition status is a beeping device.

8. The automatic shooting method as claimed in claim 1, wherein the step of executing a specific shooting procedure corresponding to the gesture image refers to a shooting procedure which takes a single picture.

9. The automatic shooting method as claimed in claim 1, wherein the step of executing a specific shooting procedure corresponding to the gesture image refers to a shooting procedure which takes three consecutive pictures.

10. The automatic shooting method as claimed in claim 1, further comprising a step of waiting for a specific number of seconds before proceeding with the specific shooting procedure.

11. A digital image capturing device with an automatic shooting function, comprising:
a processor capable of performing instant image identification;
an image capturing module, which is electronically coupled with the processor, for capturing an image; and
a memory, which is electronically coupled with the processor, comprising an identification database,
wherein the image capturing module and the memory are controlled by the processor to achieve the following mechanisms:
activating an automatic shooting process;
capturing a gesture image;
performing an instant image recognition procedure according to the gesture image;
determining whether the gesture image matches any predefined dynamic images stored in an identification database; and
executing a specific shooting procedure corresponding to the gesture image if the gesture image matches a predefined dynamic image.

12. The digital image capturing device as claimed in claim 11, wherein the gesture image of the step of capturing a gesture image is a gesture image of a user.

13. The digital image capturing device as claimed in claim 11, wherein the automatic shooting process is activated via an automatic shooting button.

14. The digital image capturing device as claimed in claim 11, wherein the identification database has a plurality of predefined dynamic images, and each predefined dynamic image is specified to a specific shooting procedure.

15. The digital image capturing device as claimed in claim 11 further comprises an indicating device for indicating a recognition status of the processor.

16. The digital image capturing device as claimed in claim 15, wherein the indicating device is a flashing device.

17. The digital image capturing device as claimed in claim 15, wherein the indicating device is a beeping device.

18. The digital image capturing device as claimed in claim 11, wherein the step of executing a specific shooting procedure corresponding to the gesture image refers to a shooting procedure which takes a single picture.

19. The digital image capturing device as claimed in claim 11, wherein the step of executing a specific shooting procedure corresponding to the gesture image refers to a shooting procedure which takes three consecutive pictures.
